(19) United States
(12) Patent Application Publication
(10) Pub. No.: US 2024/0181752 A1
(43) Pub. Date: Jun. 6, 2024

(54) DYNAMIC LAMINATED GLAZING

(71) Applicant: AGC GLASS EUROPE, Louvain-la-Neuve (BE)

(72) Inventors: Tokihiko AOKI, Gosselies (BE); Quentin GILLARD, Huy (BE); Marek NOVOTNY, Namur (BE)

(73) Assignee: AGC GLASS EUROPE, Louvain-la-Neuve (BE)

(21) Appl. No.: 18/553,795

(22) PCT Filed: Apr. 12, 2022
(86) PCT No.: PCT/EP2022/059694

§ 371 Date: Oct. 3, 2023

(30) Foreign Application Priority Data
Apr. 15, 2021 (EP) 21168713.2

(51) Int. Cl. B32B 17/10; B32B 1/00

(52) U.S. Cl. CPC B32B 17/10504; B32B 1/00; B32B 17/10036; B32B 17/10302; B32B 17/10697; B32B 17/10706; B32B 17/10917; B32B 2605/00

(57) ABSTRACT

The present invention relates to an automotive curved laminated glazing (1) comprising (i) a first glass sheet (11) having an outer (P1) and an inner (P2) faces, (ii) an electrically powered functional film (13), (iii) a second glass sheet (12) having an outer (P3) and an inner (P4) faces. (iv) at least one optical coupling material (14) being a layer of polymer that is polymerized or cured from a liquid resin and provided between the said functional film and the at least first (11) and/or the second (12) glass sheets. According to the present invention, the curved laminated glazing has at least 50% of the total surface area of the outer face (P1) of the first glass sheet (11) and the inner face (P4) of the second glass sheet (12), having a minimum radius of curvature (R min) comprised between 75-8500 mm.

### FIELD OF THE INVENTION

The present invention relates to an automotive curved laminated glazing, in particular a laminated glazing intended to be used as a dynamic glazing.

### BACKGROUND OF THE INVENTION

The invention is primarily intended to be applied to automotive glazing. The present invention relates to any glazing comprising a functional film, in particular when said glazing is subject, during its manufacture or its use, to constraints, in particular in terms of heat treatments and/or pressure. For example, in the architectural field such glazings are dynamic glazings that may be darkened at will, in particular electronically, in order to protect against the heat of the sun and glare. In the construction field, smart windows can be darkened at will when the weather is sunny in order to prevent the passage of light into a room, or lightened when the weather is cloudy in order to once more maximize the passage of light or light from display in case the dynamic glazing comprises an integrated display. However, in the architectural field, the glazings are generally flat or have a weak curvature.

In the automotive field, such glazings are for example used as the roofs, windshields, rear windows and side windows of vehicles. In particular, glazed roofs are increasingly being substituted for conventional roofs, which form part of the body of vehicles. As in the architectural field, the choice of these roofs is the result of constructors offering to their customers this option, which makes a vehicle seem to open onto the exterior, like a convertible, without the disadvantages of convertibles, as these roofs maintain the comfort levels of a conventional sedan.

Also, it is more and more requested from designer and car manufacturers to have side or rear windows provided with a functional film such as a switchable film to control the light level entering inside the vehicle for thermal comfort and/or for privacy and acoustic comfort. The latter is maintained, indeed even improved, by the presence of the laminated structure. It is known and common to laminate with an interlayer plastic sheet. However, bent or tempered glass with a functional film is difficult to be used in interlayer lamination, because of the lack of required flatness.

Also, automotive designers are looking for using at least one of the automotive glazing as display. Thus, it is desired to integrate a display into a glazing and more particularly into a laminated glazing. However, laminate a display into a bent glazing is difficult. Furthermore, the display may be combined with a switchable film to increase the light contrast while keeping a thermal comfort and/or privacy.

Automotive glazings such as roof, windshield, back-lite and side lite are generally bent to fit with the design of the car. The bent shape is more and more complex with high value of curvature. The bent shape is commonly obtained by applying a pressure and/or a heating on the laminated glazing. According to the present invention, the bending processes are those commonly and well known by skilled man in the art to bent automotive and/or architectural laminated glazing.

In the prior art, the use of liquid crystal (LC) films in glazings has been envisaged as a way of providing controllable visual isolation. In these applications, the main function is the transformation of an essentially transparent glazing into a glazing that is simply translucent. These applications did not involve specific bending characteristics.

Unfortunately, liquid crystal (LC) films as such other functional films intended to be used as switchable glazing are sensitive to pressure limiting consequently their use in complex shaped glazing such as bent sunroof, part of a windshield, side lite, backlite for automotive. The functional film may be also sensitive to thickness variation between the functional film and the glazing within it is laminated. Thus, black spots which drive from inhomogeneous pressure during the assemble process may appear in bent laminated glazings comprising a such functional film leading to an unaesthetic glazing refused generally by car manufacturers and the final customers.

It is also known to use at least one thicker glass sheet (ex: 5 mm) or pre-laminate two thin glass sheets (ex: 2.1 mm/interlayer/2.1 mm) before the final lamination with the functional film and a third glass sheet since the assembly operation with thinner glass sheet is particularly challenging. Unfortunately, if these technics make the problem easier to solve, they also lead to non-standard and heavier product structures which is not acceptable for most car manufacturers. The present invention claims to tackle the challenge of pressure sensitive functional film integration without considering such tricks.

Thus, there is a need for a process to laminate a functional film and more particularly a pressure sensitive functional film into a curved laminated glazing.

### SUMMARY OF THE INVENTION

The present invention provides a laminated glazing with a functional film that may be integrated into a bent shape glazing.

More particularly, the present invention concerns an automotive curved laminated glazing comprising at least:
a. a first glass sheet having an outer (P1) and an inner (P2) faces,
b. an electrically powered functional film,
c. a second glass sheet having an outer (P3) and an inner (P4) faces,
d. at least one optical coupling material being a layer of polymer that is polymerized or cured from a liquid resin and provided between the said functional film and the at least first and/or the second glass sheets.

According to the present invention, the curved laminated glazing has at least 50% of the total surface area of the outer face (P1) of the first glass sheet (11) and the inner face (P4) of the second glass sheet (12), having a minimum radius of curvature (R min) comprised between 75-8500 mm.

According to one embodiment of the present invention, the optical coupling material is in contact with the functional film to maintain a distance between the functional film and the at least the first and/or the second glass sheet.

According to one embodiment of the present invention, the distance created by the optical coupling between the first or second glass sheet and the film is comprised between 100 μm and 2 mm. More precisely, the optical coupling can have a thickness of around 200 μm in between the inner glass and the film and around 1 mm in between the outer glass and the film. Thus, the difference of linear thermal expansion between glass and functional film may be managed.

The present invention relates also to an automotive curved laminated glazing comprising a pressure sensitive functional film. According to the present invention, the glazing has a three dimensional (3D) curvature.

According to the present invention, a functional film and particularly a functional film sensitive to pressure, and more particularly a switchable film such as a liquid crystals film may be used in a laminated glazing like a bent roof for automotive, a side window (lite), a part of a windshield . . .

Today, automotive glazing such as sunroof, windshield, lateral windows (also called “side lite”) are more and more complex in term of shape, involving a significant curvature and comprise more and more functional films like switchable film, display . . . . To reach the required shape of the laminated glazing, the glass sheets are bent. However, the functional films are generally sensitive to high pressure (0.04 MPa-0.14 MPa) and high temperature (more than 90° C.) as applied during common lamination process used in automotive fields.

The classical known lamination processes of bent glass sheets with a functional film sensitive to pressure lead to presence of spots and unaesthetic glazings which are not acceptable for car manufacturer and customers.

The goal of the present invention is to obtain a laminated glazing with functional film sensitive to pressure with good aesthetic and a process to manufacture a such glazing.

By “sensitive to pressure” it is meant that sensitive to the pressure used to laminate the functional film between the first and the second glass sheet. The pressure is generally comprised between 0.04 and 0.14 MPa.

By “optical coupling material being a layer of polymer that is polymerized or cured from a liquid resin”, it is meant optical clear adhesives or optical clear resin. The liquid resin is preferably chosen amongst acrylic resin, methacrylate resin, urethane resin, silicone resin, polyester resin, epoxy resin and polysulfide resin or a mix. Optical coupling clear adhesive may be in the form of film type adhesive, also called optical coupling adhesive or OCA. The optical resin are before being applied in a viscous state and then it is called liquid optical coupling adhesive or LOCA. The advantage of using optical clear resin is that it can cover the entire film surrounding regardless of glass shape or even if there is a mechanical pattern on the film.

By “electrically powered functional film” it is meant for example electrochromic means in which the variation is obtained by modifying the state of colored ions in compositions included in these glazings. It is also a question of glazings comprising, in suspension, layers of particles that, depending on the application of an electric voltage, are or are not ordered, such as the systems referred to as suspended particles devices (SPDs), or even a polymer-dispersed liquid-crystal (PDLC) film consisting of a polymer containing liquid crystals sensitive to the application of the electric voltage. More particularly, the “electrically powered film” is a liquid crystals (LC) film providing controllable visual isolation. In these applications, the main function is the transformation of an essentially transparent glazing into a glazing that is simply translucent. The electrically powered functional film may be a display film which is electrically operated to illustrate pictures and/or videos to be seen from the outer and/or inner of the vehicle wherein the glazing is placed. The “electrically powered functional film” may be made of OLED and more particularly well known AMOLED. The glazing according to the present invention may comprise a combination of one switchable film and OLED film.

According to the present invention, the term “curved” is defined by the following criteria: “the curved laminated glazing has at least 50% of its total surface area having a minimum radius of curvature (R min) comprised between 75 and 8500 mm”. Thus, considering as example, a standard automotive laminated glazing, there are four main glass surfaces which are usually numbered 1 (outer surface) to 4 (inner surface) also called P1, P2, P3 and P4 (from outer to inner of the vehicle). These glass surfaces have preferably before assembly very similar shapes. In the scope of the present invention, the outer surface P1 of the first glass sheet and the inner surface P4 of the second glass sheet have at least 50% of its surface area having a minimum radius of curvature comprised between 75 and 8500 mm after assembly. As reminder, at each point of a surface, an infinity of curvature radii can be evaluated (one for each direction). Among those radii, a minimum value “Rmin” and a maximum value “Rmax” value can be identified (as well as their associated directions). Of course, from one point to another on the surface, “Rmin” and “Rmax” (and their associated directions) will change.

According to one embodiment of the present invention, a plurality of spacers are provided between the functional film and the first and/or second glass sheet, the said spacers being placed over at least a part of the surface of the functional film or over at least a part of the surface of the first and/or the second glass sheet in contact with the functional film, to maintain a distance between the functional film and the at least the external and the internal glass sheets and embedded in the said optical coupling material.

The spacers and optical coupling material have substantially the same refractive index. In a preferred embodiment, the difference between the value of the refractive index of the optical coupling material and the spacers is at maximum 15% and preferably less than 10%. According to the present invention, the spacers are embedded in the optical clear resin, the optical clear resin is used to glue the functional film to the first and the second glass sheet.

According to the present invention, the optical coupling material provided between the said functional film and the at least the first and the second glass sheets has a refractive index comprised between 1.38-1.5, preferably 1.4-1.45. The spacer is then transparent.

According one embodiment of the present invention, the transparency of optical coupling material and spacer are higher than 90%, preferably 95%, more preferably 99% at designated height of the spacers.

Thus, the spacers are not “visible” from the compartment of the vehicle.

According one embodiment of the present invention, the spacers have a height comprised between 0.3-0.7 mm, preferably 0.35-0.6 mm, more preferably 0.4-0.55 mm. Thus, the functional film is distant from the first and/or the second sheet of glass sheet of 0.3-0.7 mm, preferably 0.35-0.6 mm, more preferably 0.4-0.555 mm. Having shorter spacers will lead to the stick of the functional film to the first and/or second glass sheets, the assembly will be then difficult to handle. Conversely, if the height of the spacers is higher than 0.6 mm, the total laminated glazing thickness will increase which is not acceptable for the vehicle, especially for sidelites of vehicle.

In a preferred embodiment, the spacers are placed over the both sides of the functional film in contact with the first and the second glass sheets.

According to one embodiment of the present invention, a solar control film/interlayer may be provided between the first outer glass sheet (P2) and the optical coupling material including or not spacers. Then the spacers are not in direct contact with the surface on the glass sheet.

According to one embodiment of the present invention, all spacers are separated from each other by a pitch P comprised between 20 to 70 mm and preferably between 30-60 mm. Below a pitch P of 20 mm, the number of spacers will be to high leading to a difficulty to manipulate the assembly. Also, the spacers will be more visible due to their high number. Above a pitch P of 70 mm, there will be more space between each spacer leading to a higher surface of the functional being in direct contact with the first and/or the second glass sheets. Then, there will be a risk than the functional will stick to glass when handling

According to one embodiment of the present invention, the spacers are made of silicone. Thus, the spacers may be fixed to the functional film and the first and/or the second glass sheets during the bonding of the functional film to the first and the second glass sheets with the optical coupling material.

Also provided is a process to manufacture an automotive curved laminated glazing comprising an electrically powered film which is particularly sensitive to pressure.

The method according to the present invention comprises the following steps:
a. Providing a first glass sheet having an inner and an outer face,
b. Providing an electrically powered functional film over the inner face of the first glass sheet,
c. Providing a second glass sheet over the other side of the functional film
d. laminating at least the first and/or the second sheet of glass and the functional film by applying an optical coupling material, the optical coupling material being a layer of polymer that is polymerized or cured from a liquid resin, the optical material being provided on at least a part of the surface between the first and/or the second glass sheets,

wherein the first and second glass sheet have a curvature that after the glazing is laminated, the glazing has at least 50% of its total surface area having a minimum radius of curvature (R min) comprised between 75 and 8500 mm.

According to one embodiment of method of the present invention, the first and/or the second sheet of glass are bent in a previous step before providing the functional film over at least one surface of the first and/or the second sheet of glass.

According the invention, the term “laminating” refers to a step of providing a layered structure in which the functional film and more particularly the switchable film alone or in combination with another functional film, and one or more glass sheets are separated by an adhesive interlayer extending across substantially the entire interface between the functional film and the glass facing the functional film. The lamination step may be a cast lamination of the functional film or roller lamination of the functional film, or collectively called liquid resin lamination. A casting method includes empty panel-forming, liquid resin-filling and resin-curing. A roller lamination method includes liquid resin distribution and resin curing. The glazing according to the present invention comprises a functional film and more particularly a switchable and/or display film and more particularly a switchable and/or display film sensitive to pressure, positioned between a first and a second glass sheets. A cured or partially cured resin layer is bonding to outer surface of functional film and the inside surface of glass facing the functional film. However, other configurations and inclusion or omission of the apparatus may be possible. The terms “laminating” and “resin laminating” are understood to include creating a solid or semi-solid layer between the first and or the second glass sheets and the functional film. “Liquid resin lamination” includes cast lamination and roller lamination. For example, liquid resin, such as an acrylic system or polyurethane system or epoxy system or polyester system or silicone system or polysulfide, is used to fill the space between the functional film and the glass facing the functional film and is cured to form a cast laminated glazing according to the invention. The cured resin becomes an interlayer in the laminated glazing and more particularly the switchable glazing. A roller lamination may also produce laminated glazing. Cast lamination and roller lamination may be collectively called “liquid resin lamination.” The liquid resin may be filled between the layers of glass by gravity filling, vacuum filling or pressure filling.

According to one embodiment of the method of the present invention, an edge sealing material is provided along the periphery of the first and/or the second sheet of glass. The sealing material, amongst other properties, plays the role of delimiting the optical coupling material. An edge seal is used to seal the glazing to form a cavity between a first and a second glass sheets. The cavity is filled with a liquid resin (also called liquid optical coupling adhesive or Liquid optically clear adhesive LOCA) or a layer of polymer that is polymerized from a liquid resin (OCA) also called optical coupling adhesive or optically clear adhesive. For example in various embodiments, spacers may be added into layer of cured resin before the liquid resin is cured to maintain uniformly a distance between the functional film and the glass sheet and to ensure that liquid resin may easily cover the entire surface of the functional film and more particularly the switchable film and surface of glass sheet facing the functional film. The permanent tape or seal may be used on the perimeter of glass sheet, so that edge seal may cover the edge of glass sheet to enhance a bonding between the two layers of glass sheets. Suitable edge seal materials may include adhesion tapes, liquid adhesives, or gelatinous adhesives. The adhesive may be applied with a patterning delivery system. After curing the resin, the adhesive or other sealant material may be allowed to stay in the glazing or be removed.

The foregoing detailed description is given primarily for clearness of understanding and no unnecessary limitations are to be understood therefrom for modifications can be made by those skilled in the art upon reading this disclosure and may be made without departing from the spirit of the invention.

### BRIEF DESCRIPTION OF THE DRAWINGS

A better understanding of the present invention will be added upon reference to the following description in conjunction with the accompanying drawings.

FIG. 1 is a schematic view of one embodiment of a laminated glazing of the present invention.

FIG. 2 is a schematic view of an example of an automotive roof according to the present invention.

FIG. 3 is a schematic view zoomed of an automotive roof according to one embodiment of the present invention.

FIGS. 4a to 5b are a schematic view of surface area of a side laminated glazing wherein the distribution points is measured.

### DETAILED DESCRIPTION OF THE INVENTION

For simplicity, the numbering of the glass sheets in the continuation of the description refers to the numbering nomenclature conventionally used for glazings. Thus, the face of the laminated glass which is in contact with the environment external to the vehicle is known as being the face 1 and the surface in contact with the internal medium, that is to say the passenger compartment of the vehicle, is known as face 4, the functional assembly according to the present invention being positioned between the faces 2 and 3, where it can be protected from damage.

In order to avoid any doubt, the terms “external” and “internal” refer to the orientation of the glazing during the installation as glazing in a vehicle.

Today, more and more bent glazings such as roof, backlite, having an electrically powered film are requested by the designers and/or car manufacturers.

Unfortunately, at the present time, no solution has been proposed to laminate a large curved glazing with a functional film such as a LC film sensitive to pressure such as applied to classical and well known to laminated automotive glazings.

Thus, the present invention proposes a solution to solve at least these two problems simultaneously namely bending an electrically powered film and laminating it to form a glazing ready to be fixed to an automotive.

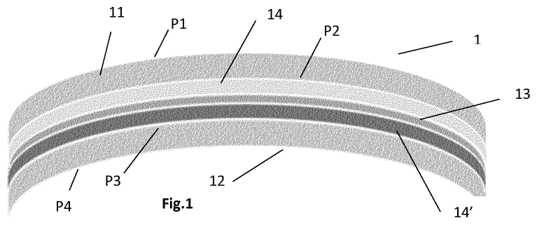

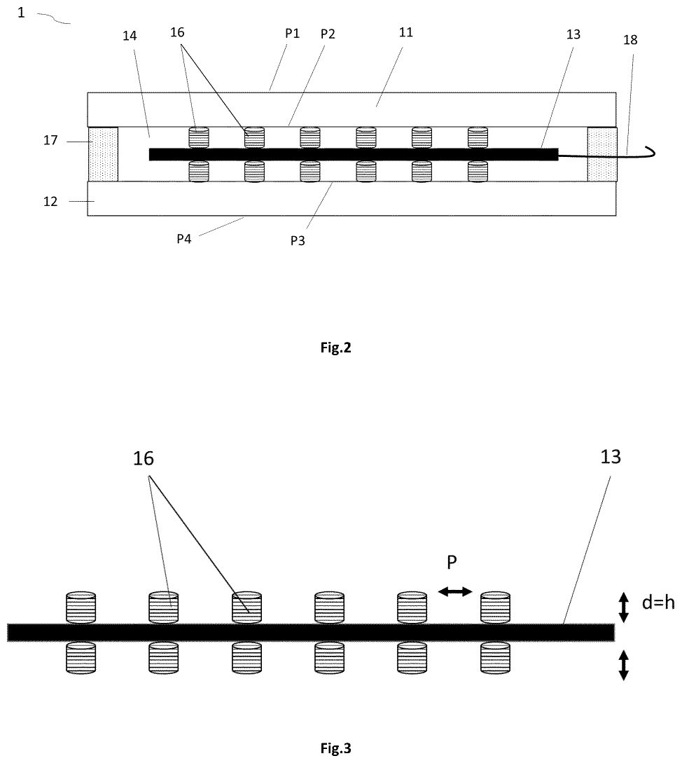

According to one example of the present invention, the FIG. 1 shows a laminated automotive roof; the roof is intended to be fixed on the vehicle's body. It is understood that the invention is not limited to a roof and in another preferred embodiment of the present to a lateral (or side) vehicle's window (also called “side lite”).

The glazing 1 as shown in FIG. 1 as an embodiment of the present invention comprises an first outer sheet of glass 11 having an external surface (P1) and an inner surface (P2), and a first inner sheet of glass 12 having an inner surface (P3) and an outer surface (P4). Such glazing 1 is laminated. The outer sheet of glass 11 of the glazing 1 is that sheet in contact with the exterior of the vehicle. The inner sheet of glass 12 is that sheet in contact with the inner space of the vehicle.

According to the present invention, an electrically powered film 13 is provided between the outer 11 and the inner 12 sheets of glass. According to one embodiment of the present invention, the electrically powered film 13 is a film sensitive to pressure such as pressure applied during a classical lamination process including autoclave bend a glazing. This kind of pressure is a pressure comprised 0.04 MPa and 0.14 MPa. The functional film is for example a LC film which is known to be sensitive to pressure. It is understood the functional film may be a LC film, an OLED film, PDLC film, SPD film or other functional film sensitive to pressure as described previously.

According to the present embodiment of the invention, at least one of the first or the second glass sheet 11, 12 and the functional film 13 are held in contact with an optical coupling material 14, 14′, the optical coupling material 14, 14′ being a layer of polymer that is polymerized or cured from a liquid resin, to create the laminating glazing 1 according to the present invention. The optical coupling material 14, 14′ serves to the adhesion and makes contact between at least one of the first or the second sheets of glass. In this example, the optical coupling material 14, 14′ is provided for the contact between the first surface of the inner sheet of glass (P3) and the second surface of the outer sheet of glass (P2). One example of a manner to apply the optical resin 14, 14′ is described below.

According to one embodiment of the present invention, the optical clear resin 14 has a refractive index about 1.4-1.45. The optical clear resin 14, 14′ may be one classically used to manufacture LC displays (LCD). Such optical clear resin is for example thermal cure type, high elongation silicone gel. The optical clear resin preferably cures at lower temperature than 70 degree C. during a period on 25 to 30 minutes to a soft, tacky gel. The soft nature and cushioning effect of this product provides excellent protection of electronic assemblies from external humidity, mechanical shock and vibration. Such optical clear resin is for example the commercial OP4012L® supplied by Momentive® company.

The optical clear resin 14, 14′ according to the one embodiment of the present invention covers all the surface of both sides of the functional film 13 to insure a good adhesion and sealing between the outer 11 and the inner 12 sheets of glass. According to one embodiment of the present invention, the optical clear resin 14, 14′ is injected between the functional film and the first and/or the second glass sheets and over the surface of the functional film 13

According to the present invention, the optical coupling material 14 may be provided on one side of the functional film in the form of a layer of polymer that is polymerized from a liquid resin as an adhesive film and on the opposite side in the form a polymer cured from a liquid resin.

According to one embodiment of the present invention, a sealing material 17 applied along the peripheral edge of the glass. The sealing material 17 stops the optical coupling resin 14 to flow out in filling process. The sealing material 17 delimits the area of applying the optical clear resin 14. In a preferred embodiment of the present invention, the optical coupling resin 14 covers all the surface of the functional film 13 and extends to cover also its edges to the sealing material 17. Such sealing material is for example the commercial TN8000 supplied by Momentive® company or MS9320 supplied by Henkel® company or SL420HW from Konishi® company. Sealing material 17 can be composed of two or more materials to enhance the protection the functional film from external damage such as moisture. According to the present invention, the optical coupling material (14) is in contact with the functional film (13) to maintain a distance (d) between the functional film (13) and the at least the first (11) and/or the second (12) glass sheet and wherein the curved laminated glazing has at least 50% of its total surface area having a minimum radius of curvature (R min) comprised between 75-8500 mm.

Generally, in the preparation of such laminated glazings according to the invention, and in particular vehicle roofs, side windows, it is advisable to consider the ability of the constituent elements to withstand the treatments that are used to shape/bend and assemble the glazing. In practice, functional films such as, inter alia, SPD films or even PDLC films, OLED films such as AMOLED films are sensitive to pressure rises. Above 0.04 MPa which is the pressure used to laminate a laminated glazing comprising a functional film, the film sensitive to pressure may deteriorate. When the functional film is subjected to a prolonged exposure to pressure, in particular to pressure greater than 0.03 MPa., and more particularly greater than 0.04 MPa., the functional film (LC film, PDLC film, SPD film, OLED, etc.) may be damaged (degradation of the film and for example of the switching function).

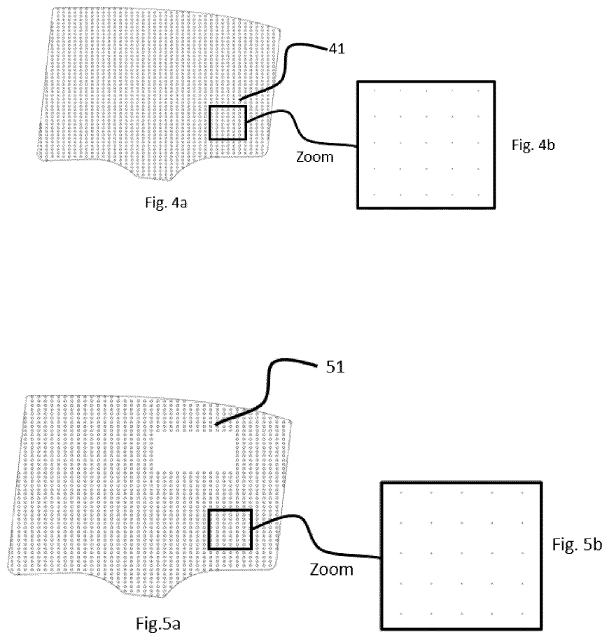

If correct from theoretical point of view, the proposed criteria to characterize the “curved” nature of the laminated glazing can be subject to different interpretations when it comes to assess it in practice. Therefore, the following practical methodology is provided as reference:
1. Select the glass surface to be assessed as “curved” or not. This surface can be the outer face of the first glass sheet (P1) or the inner face of the second glass sheet (P4) of a curved laminated glazing.
2. Reduce the surface selected at step 1 to a finite number of points “n total”. Any distribution of points can be considered, with regular pattern or not but, in any case, the whole surface must be covered with points so that a surface larger than 1 cm2 without any point cannot be found. FIG. 4a & FIG. 4b show of a valid distribution of points on a selected surface 41 (P1 or P4 surface of a laminated automotive sidelite for this example). FIG. 5a & FIG. 5b show an invalid distribution of points on selected surface 51 (P1 or P4 surface of a laminated automotive sidelite for this example) because the whole surface is not covered with points (presence of a rectangular area larger than 1 cm2 without points).
3. Measure the Rmin value at each point and determine if Rmin is inside the range [75-8500] mm or not
   If Rmin is inside the range [75-8500] mm, “n_criteria_ok” counter is increased by one 1,
   If Rmin is outside the range [75-8500] mm, “n_criteria_ko” counter is increased by one 1.

At the end of this operation, the sum of “n_criteria_ok” and “n_criteria_ko” will be equal to “n total” which is the total number of points on the selected surface.
4. Compute the ratio “n_criteria_ok” divided by “n total”
   If this ratio is at least 50%, the selected surface is “curved” according to the criteria according to the present invention,
   otherwise, the selected surface is not “curved” according to the criteria according to the present invention.

Thus, the functional film, when it is incorporated into a laminated glazing and positioned on a vehicle, in particular as glazed roof or side window, advantageously has to have a good aesthetic and a quick switch in mode ON/OFF in case of switchable film and clear image/information/video in case of integrated display such as OLED display.

Thus, the invention relates to any laminated glazing, whether tempered or not, that comprises a functional film that is sensitive to pressure, and the glazing has a complex curvature to fit with the design of the automotive.

According to one embodiment of the present invention, the optical coupling material provided between the functional film and the first and/or second glass sheets is an optical clear liquid resin. The optical clear resin is then applied in a viscous state (liquid resin) over the surface of a side of the functional film, and more particularly a switchable film (in combination or not with another function film like an AMOLED display). The optical resin is then in contact with the second glass sheet, meaning the outer surface P3 of the glass sheet.

According to one embodiment of the present invention, the optical coupling material provided between the functional film and the first and second glass sheets is an optical clear liquid resin. The optical clear resin is then applied in a viscous state (liquid resin) over the surface of the both sides of the functional film in contact with the first and second glass sheets.

According to one embodiment of the present invention, the optical coupling material provided between the functional film and the first and/or second glass sheets is an optical clear liquid resin. The optical clear resin is then applied in a viscous state between over the surface of on side of the functional film in contact with the first or the second glass sheets and on the other side (opposite side) of the functional film an optical coupling material made of a polymerized liquid resin in the form of a film. Thus, the layer is an optical coupling adhesive.

In a preferred embodiment, the optical clear resin and more generally the optical coupling material according to the present invention, extends over the functional film to cover its edged. In a more preferred embodiment, the optical coupling material extends to the edges of the first and the second glass sheets. Thus, the functional film is protected from the moisture. Optical clear resin are widely used in display industry. The advantages of using them are high transparency, low haze and milder temperature and pressure process condition such as the ones applied in automotive lamination process.

According to one embodiment of the present invention, the optical coupling material and more particularly the optical clear resin is a thermal cure type, high elongation silicone gel. It can also be two-component type.

According to one embodiment of the present invention and as show as example in FIG. 3, a plurality of spacers 16 are provided between the functional film and the first and/or second glass sheet 11, 12, the said spacers being placed over at least a part of the surface of the functional film or the first and the second glass sheets 11, 12 in contact with the functional film 13 to maintain a distance d between the functional film and the at least the external and the internal glass sheets 11, 12 and embedded in the said optical clear resin 14.

According to one embodiment of the present invention, the spacers 16 are separated from each other by a distance P comprises between 20 to 70 mm and preferably between 30-60 mm and have a height h equal to the distance d comprised between 0.3-0.7 mm, preferably 0.35-0.6 mm, more preferably 0.4-0.55 mm. Thus, the spacers may compensate if the pressure applied during the lamination process. In an embodiment of the present invention, the spacers 16 have a cylindric shape. The spacers have preferably a shape allowing an uniform filling with the optical coupling material 14.

According to one embodiment of the present invention the spacers 16 are made of a one component soft silicone rubber. Thus, when activated by UV irradiation, spacers cures with a short period time to a medium hardness material maintaining the distance between the functional film 13 and the outer and the inner sheets of glass 11, 12.

For example, spacers 16 are made of the commercial component Invisisil OP4921@ from Momentive company@.

According to one embodiment of the present invention, the spacers 16 are provided over at least a part of the surface of the functional film 13 in contact with the inner surface P2 of the outer sheet of glass 11 and the inner surface P3 of the inner sheet of glass 12 and then the optical clear resin 14 is provided by injection between the functional film 13 and the outer 11 and the inner 12 sheets of glass. The plurality of the spacers 16 are then embedded and fixed into the optical clear resin 14. Then, the optical clear resin 14 fills the space between the functional film 13 and the outer 11 and inner 12 sheets of glass.

According to one embodiment of the present invention, the transparency of optical clear resin 14 and the spacers 16 are higher than 90%, preferably 95%, more preferably 99% at designated height of the spacers. Thus, the laminated glazing remains transparent even if it comprises a functional film 13, an optical clear resin 14 and spacers 16.

According to one embodiment of the present invention, the functional film has a size smaller than the first and the second sheet of glass.

According to the present invention, the functional film 13 is electrically powered through a flexible connector 18. The way to connect the functional film 13 to a power is well-known.

According to the invention, the glass may be a glass of soda-lime-silica, aluminosilicate or borosilicate type, and the like. Typically, the glass sheet is float glass, having a thickness of from 0.5 to 12 mm. In transportation applications, the glass may have a thickness ranging of from 1 to 8 mm, while they may also be thinner or thicker in construction applications, like ultrathin glass from 0.5 to 1 mm, or thicker glass, from 8 to 12 mm, in addition to the thickness of from 1 to 8 mm.

In a preferred embodiment, the present invention concerns the integration of a pressure sensitive functional film between two curved glass sheets of low thicknesses comprised between 0.5 to 4 mm. The use of such thin curved glass sheets makes the assembly operation particularly challenging. Indeed, due to their low thicknesses, those two glass sheets can deform easily during the assembly step and, therefore, apply non homogeneous pressure on the functional film which finally leads to aesthetical defects visible in transmission (ex: local darker area). Thus, thanks to the present invention, it is possible to tackle the challenge of pressure sensitive functional film integration without considering such tricks.

The composition of the glazing is not crucial for the purpose of the present invention, provided said glass sheet is appropriate for transportation applications. The glass may be clear glass, ultra-clear glass or colored glass, comprising one or more component (s)/colorant(s) in an appropriate amount as a function of the effect desired. Colored glass include grey, green or blue float glass. In some circumstances, colored glass may be advantageous to provide for appropriate and desired color of the final glazing.

According to invention the laminated glazing may be provided with a coating to minimize heat loss. Low-e layers (low-emissive layer) may be provided on the face of the glazing facing the passenger compartment. In the traditional designation of the faces of laminated glazing, this is position 4. The numbering of the faces is done starting from the face exposed to the external atmosphere. The layers in question act as a filter selectively reflecting the far infrared rays emitted from the passenger compartment.

The glazing may be provided with any coating enabling to improve thermal comfort. The glazing may be provided with well-known anti-reflective and/or anti-fingerprint coating.

According to the present invention, the glazing is a curved laminated glazing having the outer face (P1) of the outer glass sheet and the inner face (P4) of the inner sheet having at least 50% of its total surface area having a minimum radius of curvature (R min) comprised between 75-8500 mm.

The glass sheet before the lamination may be totally or partially curved to reach the requested curvature of the final glazing to correctly fit with the particular design of the glass support, as the shape required for the application.

According to one embodiment, the laminated glazing may further comprise a third sheet of glass. The laminated glazing 1 may be laminated to another sheet of glass thanks to a thermoplastic interlayer. The laminated glazing 1 may be also part a multiple glazing. The interlayer typically may contain thermoplastic materials, for example, polyvinyl butyral (PVB), ethylene vinyl acetate (EVA), polyurethane (PU), polyethylene terephthalate (PET), polycarbonate, or multiple layers thereof, typically with a total thickness of from 0.3 to −1.5 mm. The interlayer may contain colorants, and thus be a colored interlayer.

According to one embodiment of the present invention, the second surface P2 of the external sheet of glass 11 comprises a UV-cut function and/or IR-cut function either by additional coating or providing an additional film.

In some case, it may be useful to mechanically reinforce the outer glass sheet by a thermal treatment to improve its resistance to mechanical constraints. It may also be necessary to bend the vehicle glazing at high temperature for specific applications.

The present glazing may be useful in transportation applications, where an electrically powered functional film sensitive to pressure is provided in a glazing having a curvature.

Transportation applications include those vehicles for transportation on road, in air, in and on water, in particular cars, busses, trains, ships, aircraft, spacecraft, space stations and other motor vehicles.

The present glazing may thus be a windshield, rear window, side windows, sun roof, panoramic roof or any other window useful for a car, or any glazing for any other transportation device, where display of a sharp image may be useful. The information displayed may include any traffic information, such as directions or traffic density; or any vehicle status information, such as speed, temperature, or the like.

According to one embodiment of the invention, the present invention proposes also a method to manufacture a laminated glazing comprising the following steps:
a. Provide at first glass sheet having an inner and an outer face,
b. Provide an electrically powered functional film over the inner face of the first glass sheet,
c. Provide a second glass sheet over the other side of the functional film
d. Provide a plurality of spacers between the functional film and the first and second sheet of glass,
e. Laminate the first and the second sheet of glass and the functional film by applying an optical coupling material,
f. Wherein the said spacers being placed over at least a part of the surface of the functional film or the first and/or the second glass sheets in contact with the functional film to maintain a distance d between the functional film and the at least the first and/or the second glass sheets and embedded in the said optical coupling material.

According to one embodiment of the method to manufacture a laminated glazing having a functional film, the method comprises the following steps:
a. Provide a functional film to be electrically powered,
b. Provide a plurality of spacers over the both major surface of both sides of the functional film,
c. Bend at least a first glass sheet, the glass sheet having an inner and an outer face,
d. Provide the functional film provided with a plurality of spacers onto the inner face of the first glass sheet,
e. Provide a second glass sheet onto the other side of the functional film,
f. Provide the electrical material to electrically powered the functional film between the functional film and the first or the second glass sheet,
g. Apply an optical coupling material between the functional film and the first and the second glass sheets, the plurality of spacers being embedded into the said optical coupling material.

According to one embodiment of the present invention, the spacers are made of UV curing silicone.

The spacers may be applied through a mask having the desired shape, thickness of the spacers. The mask is designed also taken in consideration the position of each spacer and the distance (pitch) between each spacer.

The spacers is then solidified thanks to an UV curing. The spacers are applied on both sides of the functional film facing the inner face of the first and the second glass sheets.

According to the present invention, before providing the functional film onto the face of the first or the second glass sheet, a sealing material (dam) is applied along the peripheral edge of the glass. The sealing material stops the optical coupling resin to flow out in filling process. The sealing material delimits the area of applying the optical clear resin. In a preferred embodiment of the present invention, the optical coupling resin covers all the surface of the functional film and extends to cover also its edges to the sealing material.

According to the present invention, the optical coupling material is an optical coupling resin. The optical coupling material may be injected between the functional film and the first and the glass sheets.

According to the present invention, before providing the functional film onto the face of the first or the second glass sheet, the peripheral sealing material can be locally interrupted by the presence of two or several needles. Those needles are useful to inject the optical coupling resin into the glazing. Needles can have different shapes or diameters (preferably between 0,5 and 2.5 mm). Needles can be inserted at any location along the periphery of the glazing. Preferably, the configuration with two needles located at opposite corners (one used as inlet, the other one used as outlet) appears to be very convenient for the injection step. It is understood that any arrangement can be defined depending on the dimensions and the geometry of the glazing. After the injection process, needles can be removed but their presence may remain visible in the form of a discontinuity in the peripheral sealing on the final product. The size of this discontinuity is directly linked to the diameter of the needles.

According to the present invention, means to electrically power the functional film are provided into the laminated glazing according to well-known process.

According to another embodiment of the present invention, the plurality of spacers are provided over the faces of the first and second glass sheets being in contact with the functional film.

1. An automotive curved laminated glazing (1) comprising at least:
a. a first glass sheet (11) having an outer (P1) and an inner (P2) faces,
b. an electrically powered functional film (13),
c. a second glass sheet (12) having an outer (P3) and an innerter (P4) faces,
d. at least one optical coupling material (14, 14′) being a layer of polymer that is polymerized or cured from a liquid resin and provided between the said functional film and the at least first (11) and/or the second (12) glass sheets,
wherein the curved laminated glazing has at least 50% of the total surface area of the outer face (P1) of the first glass sheet (11) and the inner face (P4) of the second glass sheet (12), having a minimum radius of curvature (R min) comprised between 75-8500 mm.

2. A laminated glazing (1) according to claim 1, wherein the optical coupling material (14, 14′) being in contact with the functional film (13) to maintain a distance (d) between the functional film (13) and the at least the first (11) and/or the second (12) glass sheet and

3. A laminated glazing (1) according to claim 1, wherein the electrically powered functional film is a switchable film chosen amongst suspended particle display (SPD) film, electrochromic material film or thermochromic material or liquid crystal (LC) film.

4. A laminated glazing (1) according to claim 1, wherein the switchable film (13) comprises liquid crystal (LC) material.

5. A laminated glazing (1) according to claim 1, wherein the glazing comprises a combination of a switchable film and active-matrix organic light-emitting diode.

6. A laminated glazing (1) according to claim 1, wherein the liquid resin is an acrylic resin, urethane resin or silicone resin or polyester resin or epoxy resin or polysulfide resin.

7. A laminated glazing (1) according to claim 1, wherein the liquid resin is a photo curable resin, or UV curable or temperature curable; or chemically curable or day-light curable.

8. A method for making an automotive curved laminated glazing (1) according to claim 1 comprising:
a. Providing a first glass (11) sheet having an outer and an inner faces,
b. Providing an electrically powered functional film (13) over the inner face (P2) of the first glass sheet (11),
c. Providing a second glass sheet (12), having an outer and an inner faces, over the other side of the functional film (13)
d. laminating at least the first and/or the second sheets (11, 12) of glass and the functional film (13) by applying an optical coupling material (14), the optical coupling material (14) being a layer of polymer that is polymerized or cured from a liquid resin, the optical material (14) being provided on at least a part of the surface between the first and/or the second glass sheets,
wherein the outer face of the first glass sheet and the inner face of the second glass sheet have a curvature measured after the lamination step, on at least 50% of its total surface area of minimum radius of curvature (R min) comprised between 75-8500 mm.

9. The method of claim 8 wherein the first and/or the second sheets are bent before the bonding step c) of claim 8.

10. The method of claim 8 wherein the optical coupling material (14) is provided on the inner face (P2) of the outer glass sheet or on the inner face (P3) of the inner glass sheet.

11. The method of claim 8 wherein the optical coupling material (14) is layer of polymer that is polymerized from a liquid resin.

12. The method of claim 8 wherein spacers are provided between the first and/or the second glass sheet and the functional film and wherein spacers are embedded in the optical coupling material (14).

13. The method of claim 8 wherein the optical coupling material (14) provided on one side of the functional film is layer of polymer that is polymerized from a liquid resin and on the opposite side of the functional film the optical coupling material (14) is a layer of polymer that is cured from a liquid resin.

14. The method of claim 8 wherein the switchable film comprises liquid crystal (LC) material and/or an OLED film.

15. The method of claim 8 wherein the switchable film comprises suspended particle display (SPD) material or electrochromic material or thermochromic material.
